(19) United States
(12) Patent Application Publication
(10) Pub. No.: US 2026/0022729 A1
(43) Pub. Date: Jan. 22, 2026

(54) SELF-FASTENING THREADED INSERT AND PROCESS FOR ASSEMBLING SUCH THREADED INSERT

(71) Applicant: Specialinsert s.r.l., Torino (IT)

(72) Inventor: Piero Arduini, Torino (IT)

(73) Assignee: Specialinsert s.r.l., Torino (IT)

(21) Appl. No.: 18/779,230

(22) Filed: Jul. 22, 2024

(51) Int. Cl. F16B 37/12; F16B 13/08; F16B 13/12

(52) U.S. Cl. CPC F16B 37/122; F16B 13/0866; F16B 13/124

(57) ABSTRACT

A self-fastening threaded insert (1) is described, with respect to a slab of building material, comprising a bearing element (10) with respect to the slab, a deformation element (20) adapted to interact with the slab, a supporting element (30) cooperating with the bearing element (10), wherein the deformation element (20) is deformed due to the effect of an external load transmitted by the supporting element (30), the deformation element (20) being adapted to transmit to the slab forces which are perpendicular to an application force of the external load to be able to fasten the threaded insert (1) to the slab. A process for assembling such threaded insert (1) is also described.

### BACKGROUND OF THE INVENTION

### 1) Field of the Invention

The present invention refers to a self-fastening threaded insert and to a process for assembling a threaded insert. In particular, the present invention refers to a self-fastening threaded insert with respect to a slab of building material.

### 2) Background Art

Generally, a self-fastening threaded insert allows arranging a threaded seat on a slab of building material, such as marble, granite or other stone material, wood, glass and composite material, such as carbon and further new-generation elements of a compact nature known as “solid surfaces”.

Such threaded seat allows fastening the slab to a structure or frame to make vented facades, building coatings, building environments, furniture, sanitary elements, kitchens, funeral works of art, etc.

The prior art, represented for example, by EP 1277973 B1, refers to a small fastening block comprising a cylindrical separating body with an internal drilling. The body is axially divided into two segments, mutually connected by snap-type closures. A separating device is housed in a body recess. However, in order to fasten the small block to the slab, it is necessary to rotate the body with a tool, creating an insertion effect in the slab hole.

US-B1-10473141, of the same Applicant, discloses a self-fastening threaded insert which works only with three or more deformation elements, not being suitable for applications requiring one or two deformation elements.

US-A1-2008/0031702 discloses a prior art insert which is used in other fields of application.

### SUMMARY OF THE INVENTION

Object of the present invention is providing a self-fastening threaded insert which allows avoiding to have to recur to external means for assembling, once having obtained a hole when working with the use of standard means.

A further object is providing a self-fastening threaded insert which allows a completely disappearing assembling, without external encumbrances, to facilitate handling and storing the slabs.

The above and other objects and advantages of the invention, which will result from the following description, are obtained with a self-fastening threaded insert and with a process for assembling a self-fastening threaded insert as claimed in the respective independent claims.

Preferred embodiments and variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could be made to what is described, without departing from the scope of the invention as appears from the enclosed claims.

### BRIEF DESCRIPTION OF THE DRAWINGS

The present invention will be better described by some preferred embodiments thereof, provided as a non-limiting example, with reference to the enclosed drawings, in which:

FIG. 1 shows a perspective view of a first embodiment of the self-fastening threaded insert according to the present invention;

FIGS. 1A and 1B shows partially sectioned side views along the axis of symmetry respectively of a second and a third embodiment of the self-fastening threaded insert according to the present invention;

FIGS. 1C to 1E show partially sectioned side views along the axis of symmetry of some installation modes of the self-fastening threaded insert according to the present invention;

FIGS. 2 to 5 show partially sectioned side views along the axis of symmetry respectively of various embodiments of the self-fastening threaded insert according to the present invention;

FIG. 6 shows a perspective view of a sectioned portion of a slab adapted to house the self-fastening threaded insert according to the present invention;

FIG. 7 shows a perspective view of the slab of FIG. 6 coupled with an embodiment of the self-fastening threaded insert according to the present invention; and

FIG. 8 shows a partial and enlarged side sectional view of an embodiment of the self-fastening threaded insert equipped with an external connection element screwed according to the present invention.

### DETAILED DESCRIPTION OF PREFERRED EMBODIMENTS

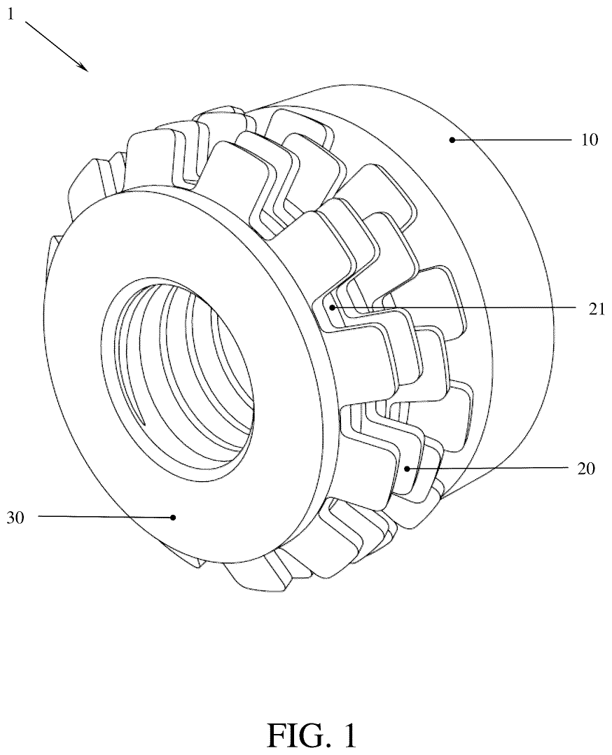

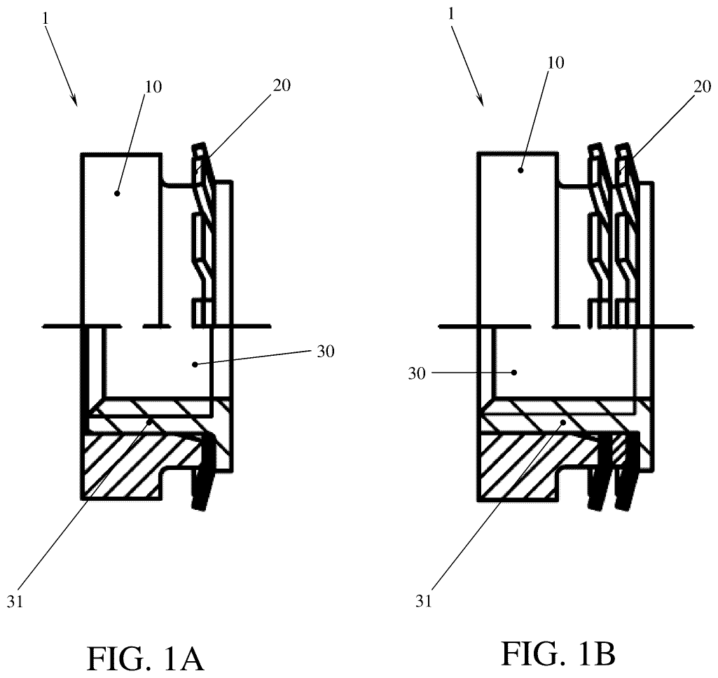

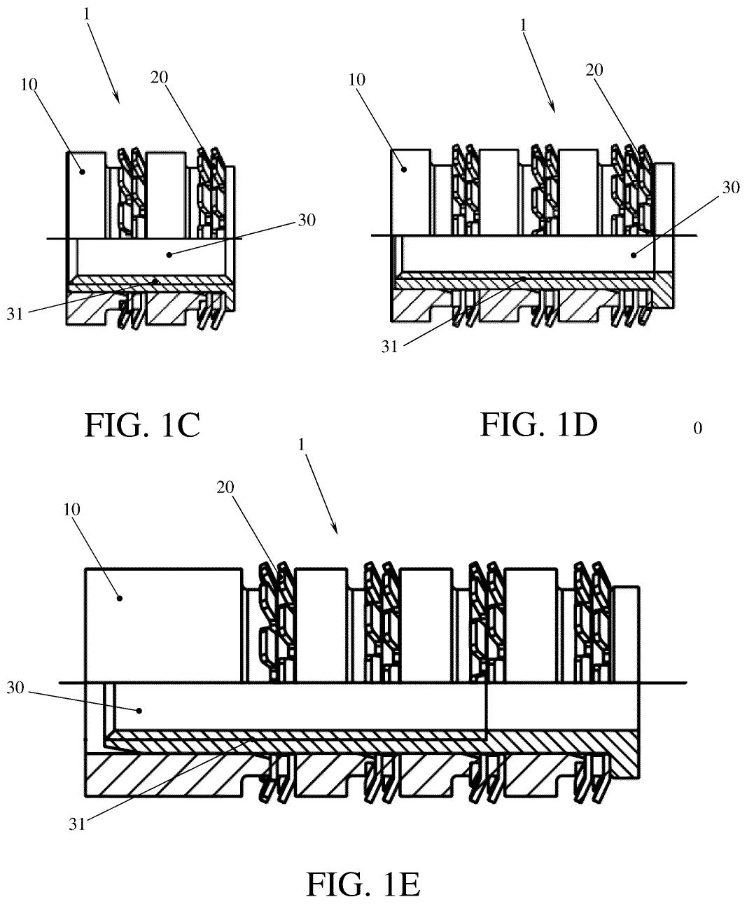

With reference to FIGS. 1, 1A, 1B, 2 and 3, it is possible to note that a threaded insert 1 with automatic fastening with respect to a slab of building material comprises a bearing element 10 with respect to the slab, at least one deformation element 20 adapted to interact with the slab, and a supporting element 30 cooperating with the bearing element 10.

While FIGS. 1 and 4 show a first embodiment of the threaded insert 1 with (for example) four deformation elements 20, FIG. 1A shows a second embodiment of the threaded insert 1 with (for example) one deformation element 20, and FIG. 1B shows a third embodiment of the threaded insert 1 with (for example) two deformation elements 20.

FIGS. 1C to 1E show partially sectioned side views along the axis of symmetry of some installation modes of the self-fastening threaded insert 1 according to the present invention, where the insert 1 can be installed two at a time (FIG. 1C), three at a time (FIG. 1D) or four at a time (FIG. 1E); obviously, the above are only some of the several possible embodiments in which the insert 1 can be installed, in any of its possible configurations with more than four deformation elements 20.

Advantageously, such deformation element 20 is deformed due to the effect of an external load transmitted by the supporting element 30. In this way, such deformation element 20 can transmit to the slab forces which are perpendicular to an application force of the external load, to allow the threaded insert 1 to get fastened to the slab.

Advantageously, the supporting element 30 can support a battery of deformation elements 20, preferably in a number ranging from 1 to 4 elements connected in series or more, depending on applications.

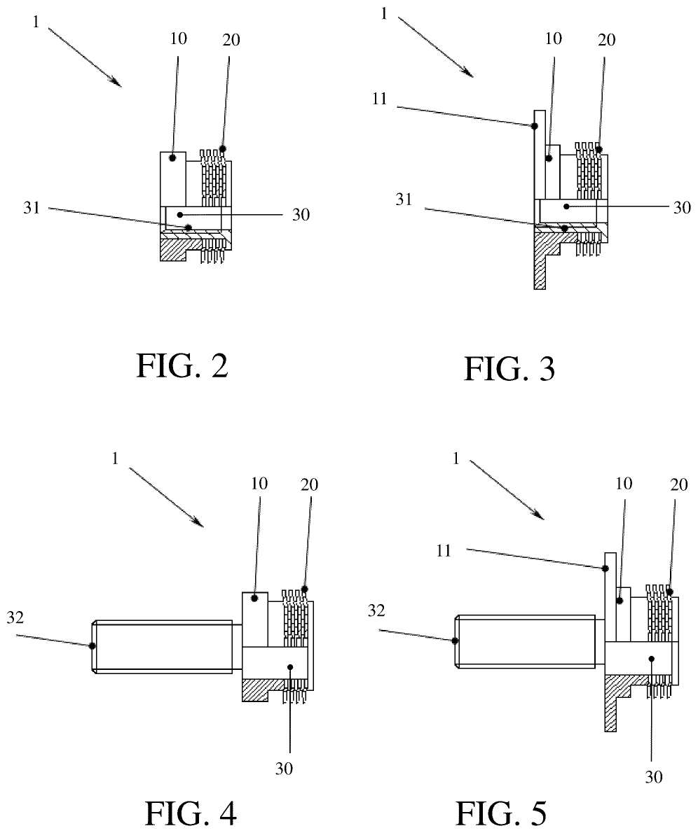

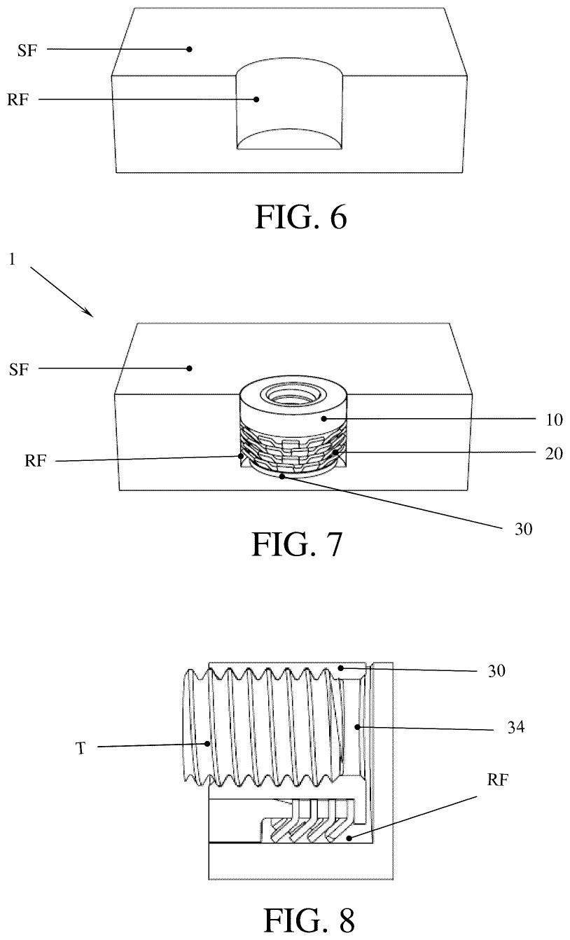

With reference to FIGS. 2, 4, 6 and 7, it is possible to note that the bearing element 10 adapted to contain the supporting element 30 is housed in a recess of the slab to allow the threaded insert 1 to abut against an internal surface RF of the recess without projecting from an external face SF of the slab.

With reference to FIGS. 3, 5 and 6, it is possible to note that the bearing element 10 adapted to contain the supporting element 30 comprises an abutment flange 11 with respect to an external face SF of the slab to allow the threaded insert 1 to abut at least against the external face SF of the slab.

At least one of such deformation elements 20 can comprise an elastic toothed crown, adapted to be housed with interference in a cylindrical recess of the slab.

Alternatively, each deformation element 20 can comprise a smooth or toothed cup spring which is smooth or toothed or with another suitable shape, adapted to be housed with interference in a cylindrical recess of the slab (not shown).

According to a preferred configuration, each deformation element 20 can be connected to at least one spacer ring 21, as shown in FIG. 1.

With reference to FIG. 8, it is possible to note that the supporting element 30 comprises abutting means 34 adapted to block a connection element T screwed to the threaded insert 1 to prevent the threaded insert 1 from going out of the recess of the slab and to prevent the slab from breaking.

Preferably, the abutting means 34 can comprise a blind threaded hole or a partially threaded through-hole to prevent a screw T from pressing onto the bottom of the recess of the slab.

With reference to FIGS. 2 to 5, the threaded insert 1 can alternatively operate as connection element through an internal threading 31 and an external threading 32.

The bearing element 10 made of plastic or metallic material, depending on the application, and the supporting element 30 made of metal allow supporting loads with a high force.

A process for assembling a self-fastening threaded insert 1 with respect to a slab of building material comprises the steps of:
performing an excavation of the slab to obtain a receiving recess;
applying the threaded insert 1 into the receiving recess to allow fastening the bearing element 10 to the slab and housing with interference, with respect to an internal wall RF of the recess of the slab, each deformation element 20 belonging to the threaded insert 1;
connecting an external element through a connection element T screwed onto the threaded insert 1.

The threaded insert 1 allows obtaining the objects of the invention, with the advantages of allowing an assembling after having performed a simple hole on the slab, even when working, with the use of standard tools, being able to quickly insert the threaded insert into such hole through a simple pressure, without having to add adhesives and gluing agents.

Moreover, the threaded insert of the invention allows performing an assembling of the threaded insert which afterwards disappears inside the slab, without external encumbrances, facilitating handling and storage of the slabs.

A further advantage is given by the absence of stresses on the receiving material when the threaded insert is not stressed, while during its use the elastic washers are stressed by an axial traction force, radially acting against the walls due to flexure and pressure, preventing the insert from going out of the slab.

The threading of the supporting element made as non-through ensures the fastening of the threaded insert onto the slab, avoiding the extraction effect generated by the possible inappropriate length of the screw.

We claim:

1. A self-fastening threaded insert with respect to a slab of building material, comprising a bearing element with respect to the slab, at least one deformation element adapted to interact with the slab, a supporting element cooperating with the bearing element, wherein the deformation element is deformed due to the effect of an external load transmitted by the supporting element, the deformation element being adapted to transmit to the slab forces which are perpendicular to an application force of the external load to be able to fasten the threaded insert to the slab, the supporting element being designed to support a battery of deformation elements.

2. The threaded insert of claim 1, wherein the deformation elements are two.

3. The threaded insert of claim 1, wherein the deformation elements are three.

4. The threaded insert of claim 1, wherein the deformation elements are four.

5. The threaded insert of claim 1, wherein the deformation elements are more than four.

6. The threaded insert of claim 1, wherein the bearing element adapted to contain the supporting element is housed in a recess of the slab to allow the threaded insert to abut onto an internal surface of the recess without projecting from an external face of the slab.

7. The threaded insert of claim 1, wherein the bearing element adapted to contain the supporting element comprises an abutment flange with respect to an external face of the slab to allow the threaded insert to abut against at least the external face of the slab.

8. The threaded insert of claim 1, wherein the deformation element comprises an elastic crown which is smooth or toothed and is adapted to be housed with interference in a cylindrical recess of the slab.

9. The threaded insert of claim 1, wherein the deformation element comprises a cup spring adapted to be housed with interference in a cylindrical recess of the slab.

10. The threaded insert of claim 4, wherein the deformation element is connected to at least one spacer ring.

11. The threaded insert of claim 1, wherein the supporting element comprises abutting means adapted to block a connection element screwed onto the threaded insert to prevent the threaded insert from being extracted from the recess of the slab and to prevent the slab from breaking.

12. The threaded insert of claim 1, operating alternatively as connection element through an internal threading and an external threading.

13. The threaded insert of claim 1, wherein the bearing element made of plastic or metallic material and the supporting element made of metal allow supporting loads with a high force.

14. Process for assembling the self-fastening threaded insert of claim 1 with respect to a slab of building material, the process comprising the steps of:
performing an excavation of the slab to obtain a receiving recess;
inserting the threaded insert into the receiving recess to allow fastening the bearing element onto the slab and housing with interference the deformation element with respect to an internal wall of the recess of the slab,
connecting an external element through a connection element screwed onto the threaded insert.
